(19) United States
(12) Patent Application Publication
(10) Pub. No.: US 2019/0147155 A1
(43) Pub. Date: May 16, 2019

(54) METHOD OF REMOTELY IDENTIFYING A PHYSICAL PERSON IN ASYNCHRONOUS MODE, AIMED AT THE RELEASE OF AN ADVANCED ELECTRONIC SIGNATURE, QUALIFIED ELECTRONIC SIGNATURE OR DIGITAL IDENTITY

(71) Applicant: INFOCERT S.P.A., ROMA (RM) (IT)

(72) Inventors: Marco DI LUZIO, ROMA (RM) (IT); Alfredo ESPOSITO, ROMA (RM) (IT); Nicole MAZZONI, ROMA (RM) (IT); Igor MARCOLONGO, ROMA (RM) (IT)

(21) Appl. No.: 16/098,508

(22) PCT Filed: Apr. 11, 2017
(86) PCT No.: PCT/IB2017/052079

§ 371 Date: Nov. 2, 2018

(30) Foreign Application Priority Data
May 13, 2016 (IT) 102016000049466

(51) Int. Cl. G06F 21/32; G06F 21/45; H04L 29/06; H04L 9/32; G10L 17/24; G06K 9/20; G06K 9/00; G06F 9/451

(52) U.S. Cl. CPC G06F 21/32; G06F 21/45; H04L 63/105; H04L 63/107; H04L 9/3247; G06F 2221/2117; H04L 63/0428; G10L 17/24; G06K 9/2063; G06K 9/00711; G06F 9/453; H04L 9/3228

(57) ABSTRACT

A method of identifying a physical person aims to obtain an advanced electronic signature, a qualified electronic signature or digital identity through the authentication to an application, the activation of which requires a functioning audio-video system and an internet connection, and includes: a user accesses the application, executes the registration process by entering his/her details and start, via encrypted channel, the onscreen wizard, following the steps indicated through audio and/or video messages proposed randomly by the application; and the qualified operator, in charge of the recognition for the checks saves, in “image capture” mode, evidence of various types, viewing all evidence and making a comparison in relation to dedicated databases. If the operator is certain, he digitally subscribes the successful recognition statement and makes a call that automatically sends an OTP code on the mobile phone. The input of the value derived therefrom confirms the registration/application form request.

The invention relates to a set of techniques and systems that make use of digital procedures for identifying and verifying the congruence of the identification data provided. More specifically, it relates to processes for the remote recognition of individuals based on the collection and examination of personal and biometric parameters.

### STATE OF THE ART

The spread of the computer tools and the parallel growth of communications through computer networks have placed with pressing urgency the problem of replacing traditional paper documents with equivalent computer systems.

Several solutions have been developed that are based on the assessment and congruence of the various information provided by the user to be identified.

For example, U.S. Pat. No. 8,925,058 of Dec. 30, 2014 relates to an authentication technique for a person which uses, in real time, a first and a second authentication factor, related to the same person. At least one between the first and the second authentication factor consists of a biometric input. A cross-check action is provided by combining the results of evaluations on the first and second authentication factor. In particular, facial recognition based on a video recording and dynamic recognition of the voice of the users that wants to be identified are used as biometric authentication factors.

Moreover, the need for “ready to use” recognition is also increasing to reach smart clients and be able to sell goods and/or services without losing the certainty of identification.

Due to the recognition via webcam used nowadays by some of the major Italian banks, the number of fraud against them has significantly reduced.

In fact, checks are more stringent during the identification, also due to the means used, and the checks on databases that until now required days of investigation of the practice are immediate.

Recognition procedures are known in which the possession of a valid identification document by the applicant is checked, followed by the storage in secure form, in accordance with the applicable regulations, of the phases and the data that led to the recognition. The patent entitled “Method of remote recognition via videoconferencing technologies” to the name of the same Applicant, filed on Jun. 7, 2013, relates to a solution where the user authenticates him/herself using his/her computer or digital mobile device, such as a mobile phone, by connecting to the recognition service request portal. The user is informed on screen about what he/she needs to continue the process, that is, a valid identification document. The user is requested, indicating in detail the types and purposes of collection thereof, his/her personal data and the number of the identification document he/she intends to use. The authorized operator carries out real-time checks by comparing the data recorded with those available on accessible databases. In particular, he/she check the existence of the natural person matching the social security number provided by the user during the request by connecting to the portal of the Inland Revenue. At further checks, the check of data is done by connecting to public databases such as the Ministry of the Interior, the Italian PRA, Experian and others.

In the steps that follow, the authorized operator contextually imparts on screen the instructions for the user to start the recognition, illustrating the steps necessary for its completion. Then, the user frames his/her face with the webcam or camera following the operator's instructions. After that, the user shows the identity document of which he/she had previously provided the number to the webcam or camera. Upon the operator's command, a photograph of both the front and back of the document is taken. Finally, the check of the conformity of the photograph on the identity document with the user's face is performed.

The key feature of this type of procedure is that the succession of steps is carried out in real time: there is in fact a continuous conversation, from beginning to end, between operator on one side and user on the other.

The recognition and verification of the user's identity therefore are two steps which are carried out simultaneously.

There remains the problem of a possible concern for the operator who works with time limits to be respected, albeit with some flexibility. These are conditions in which the operator carrying out the verification would like to have more time and carry out the check with maximum availability of operational resources.

Other times, a certain agitation may cause the operator to not clearly explain the different alternatives offered to the customer for whom there has been an initial failure of the first verification process.

At the same time, a general problem in the management of back office activities is the optimization of the throughput for a significant reduction in downtime.

Another problematic aspect of the current management of the process on the operator's side is that having binding times to access databases, the consultation of the latter may be incomplete and inaccurate.

On the other hand, to date the two steps of the acquisition of identification documents and their verification cannot be carried out at different times. For example, what is increasingly felt in the major Italian banks is the tendency to use tools that lead to a conclusion of an account opening process (or transaction in general) with a single process. In this regard, measures are adopted that facilitate the user's operations, such as online chat or live telephone support.

In this respect, the invention goes against a consolidated technical prejudice as it poses the fundamental objective to divide this process into two steps and automate as much as possible the first step of entering the identification data, separating it from the second step of verification.

The object of the present invention is therefore different from the prior art: moving the verification to a step following the input of data, making the recognition process already object of a patent asynchronous.

The fact of making the recognition asynchronous, for the man skilled in the art, is a significant difference because if to date any type of request of issuing a signature certificate must be initiated and ended simultaneously, irrespective of the identification method, the subdivision of the process into two distinct moments introduces a significant level of autonomous operation, since they are no longer temporally subordinated to each other. The asynchronous management allows the customer to execute the online recognition procedure at any time, from any device.

A last object of the present invention is to provide techniques and devices for computing and comparing the information entered that employ operating systems and access and communication protocols among the most widespread and recognized as a standard, this in order to make the embodiment of the invention immediate, reliable and easy to manage and maintain.

The above objects are achieved by a new identification data acquisition technique and new procedures of verification of the congruence of the data entered, as referred to in claims 1 to 11.

### DESCRIPTION OF THE FIGURES

For a detailed description of the exemplary embodiments of the invention, reference is now made to the accompanying drawings. In the drawings:

FIG. 1 is a general diagram that gives a rough indication of the interactions between the subjects and entities involved;

FIG. 2 is a general functional diagram relating to the typical procedures implemented to carry out the invention;

FIG. 3 is a flow chart relating to some procedures implemented to carry out the invention;

FIG. 4 is a functional diagram relating to a particular electronic embodiment implementing a particular configuration of the invention.

### DETAILED DESCRIPTION OF THE INVENTION

In the following illustrations and description, identical parts are generally denoted throughout the specification and in the figures by the same reference numerals. The present description can be implemented according to different embodiments. Specific embodiments are described in detail and shown in the illustrations, providing that the present description is to be considered an exemplification of the fundamental principles and is not intended to limit the scope to that illustrated and described herein. Moreover, the different teachings and components of the embodiments considered below may be employed separately or in any suitable combination to produce the desired results.

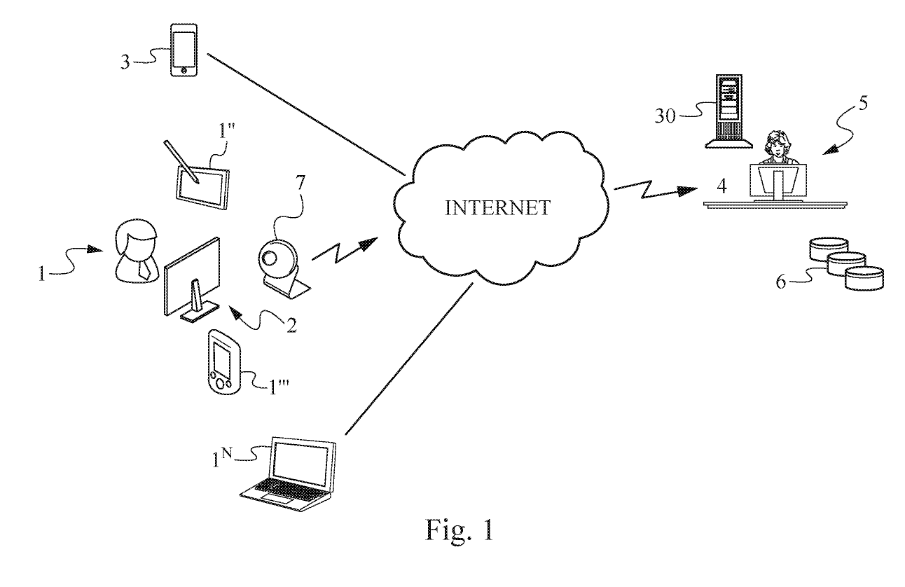

FIG. 1 is a schematic macroscopic representation of the parts involved in the process of remotely identifying a physical person in asynchronous mode, aimed at the release of an advanced electronic signature, a qualified electronic signature or digital identity. It shows a user 1 that interfaces via camera 7 of a desktop 2 or a smartphone 3. The back office 4 with the relative operators 5, who use databases 6 in which the identity data are stored, are also shown.

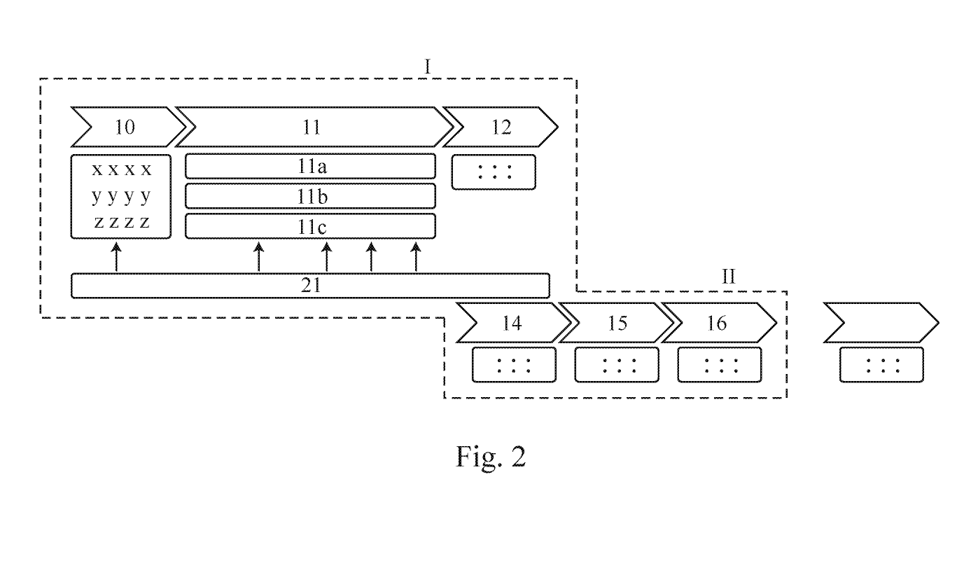

As shown in FIG. 2, the process is handled asynchronously, comprising a first part of operations that are self-made by user 1 in which the user him/herself fills in the online form 10, executes the wizard screen procedure to register 11 with device certification and submits the request 12.

I—In particular, as regards filling in 10 the online form, the user enters his/her personal data: his/her personal data: first name, last name, social security number, date and place of birth, mobile phone number, home address, type and number of identity document.

He/she also receives the full privacy statement on the processing of biometric data by the entity that collects them (a Certification Authority, hereinafter referred to as CA, or an Identity Provider, hereinafter referred to as Idp).

The wizard screen registration and device certification step 11 has in turn different sub-steps, some mandatory and others optional, in particular:
11a—shooting and uploading a video;
11b—optionally; the acquisition of additional documentation (such as a signature specimen, a copy of last pay slip, etc.);
11c—the input of the OTP (One Time Password) value derived from the code received on the mobile phone indicated during registration (an example of this value is a combination of numbers or the result of a mathematical calculation that is prompted to the user, or the value may be represented by a barcode or a QR code). The continuation will be possible only in case of success.

In fact, at the end of procedure 11a, the user is notified that he/she will receive a text message with instructions for completing the procedure. At the end of the registration, the request is sent 12.
II—The asynchronous acceptance step by operator 5 also provides a number of standard operations to be performed. In particular, the operator accesses to the workstation by using strong authentication (two-factor). Once authenticated, operator 5 selects 14′, among the onscreen frames, one that best matches the user's face and identity documents, then he checks 14″ the validity of the latter; with such data, he accesses public databases such as the Ministry of the Interior, the Italian PRA, Experian and others.

More in detail, operator 5, asynchronously, views all the evidence submitted by user 1, time-stamps them and compares them (such as by checking whether the photo on the identity document matches the face of the person displayed in the video). With this information, he queries databases and the relative results are stored by the CA/Idp.

At the end of the checks, operator 5 may decide to apply some additional optional checks, such as schedule a short phone call 16—entirely optional—and for this purpose he sends a text message to the mobile number verified and associated with the user suggesting a date (example text: “Thank you for choosing the simplified recognition . . . you will be contacted the xx/xx at xx:xx. If you answer “Yes” to this message, we will fix the date”).

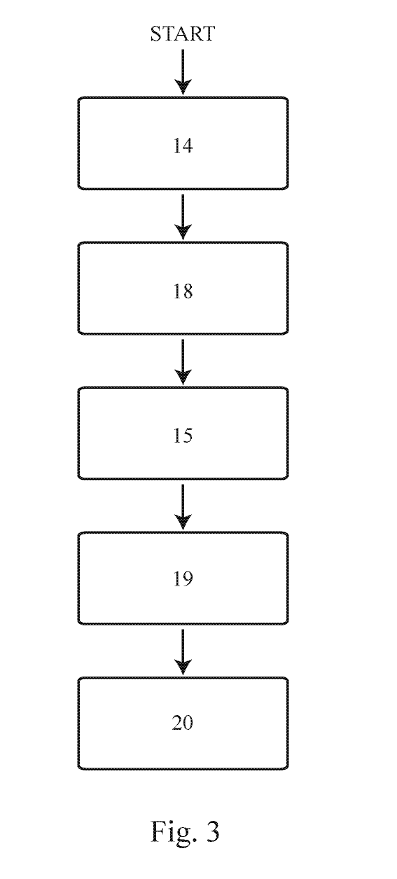

As said, in the first part of the procedure, operations are delegated as much as possible to the user. User 1, alone, follows the self-made procedure and sends the video in encrypted mode, on a secure channel. Compared to the previous solutions, changes have been made mainly on the back office 4 checks, i.e., although nowadays videoconferencing is live, using the asynchronous solution object of the present patent application, one is assured that the evidences are the same and the robustness of the operational algorithm has been established. In fact, as shown in FIG. 3—where a further schematization of the execution process of the title according to the present invention is shown—it should be noted as also from the point of view of the operator 5, despite the data input by user 1 in asynchronous mode, a strict and severe evaluation of the reliability of data entered is executed anyway. In particular, in step 14, as mentioned, videos, face photos and documents taken by the operator himself, and the signature specimens (when required) are managed by operator 5. The same operator provides time stamping of all evidence. At the same time, the logs of all the operator's back office checks are highlighted in 18. Following the identification information, operator in 15 examines the results of the database query. Finally, there is the successful recognition statement 20, digitally signed by the operator (also called responsible for registration, IR).

In the preferred embodiment of the present invention, it is contemplated that the process of identifying an individual user 1 takes place asynchronously by means of authentication from mobile or desktop application having as ultimate objective the remote issue 20 of an advanced electronic signature, qualified electronic signature or digital identity. It is assumed that there is an audio-video system running as the user authenticates using his/her computer 2 or digital mobile device 3, such as a mobile phone, by connecting to the recognition service request portal. The user's 1 workstation is equipped with a webcam or a digital camera with the ability to record video 7 as well as a sound system, for example complete with headphones and speaker, or as needed in hardware and software for an audio/video session.

It is contemplated that the user accesses the mobile 3 or desktop 2 application and start the registration process by entering his/her personal data: first name, last name, social security number, date and place of birth, mobile phone number, address, type and number of identity document; then, he/she read the full privacy statement on biometric and identification data processing by the CA and by third parties for the purposes of recognition.

User 1 is informed on screen with appropriate messages or by an avatar about what he/she needs to continue the process, that is, a valid identification document. In this first self-made step, user 1 is requested, indicating in detail the types and purposes of collection thereof, his/her personal data and the number of the identification document he/she intends to use. An expert system 21 carries out real-time checks by comparing the data recorded with those available on accessible databases 6. In particular, he makes first checks on the existence of the individual, such as the social security code provided by the user during the application or the consistency of the data provided, for example based on the matching between name and birth date, document expiration, etc.

If these preliminary checks are successful, the user gives his/her mandatory consents to data processing by setting an acceptance flag and initiates, via encrypted channel, the onscreen wizard by following the steps indicated audio and/or video messages proposed randomly by the application. In detail, the expert system 21 gives via audio instructions to the user to start the recognition, illustrating the steps necessary for its completion. Then, the user frames his/her face with the webcam or camera 7 following the expert system's instructions. After that, user 1 shows the identity document of which he/she had previously provided the number to the webcam or camera 7. All evidence collected, i.e. the personal data of user 1 and the entire audio/video recording of the recognition session is stored in secure form in a compliant storage system.

The recording carried out during the self-made process, once sent via encrypted channel, must be of a suitable quality to allow the operator in the back office to take the following frames in “image capture” mode:
1. user's face;
2. (front and rear) user's identification document;
3. (front and rear) user's social security number.

If access is fraudulent and incorrect inputs are due to a suspect login attempt, as will be better seen hereinafter in the description, these attempts are detected and stored to be then provided to the back office operator.

The recording must also contain, in addition to the evidence referred to above, the certification of the mobile number by the reception of a control code sent via text message to the user (One Time Password) and subsequent input into a dedicated field.

When the recording is complete, it is sent automatically to the back office system via an encrypted channel. The back office system 4 receives the video recorded by user 1 and sets it up to be managed by an available qualified operator 5 (in charge of the identification); The qualified operator (in charge of the identification), in asynchronous mode with respect to the video recording, times-stamps it upon reception and starts executing the prescribed checks in order to identify the user.

To improve the process, as said, having introduced the division into two different times, the operator acquires the evidence for each user and calmly perform verifications and checks without the hassle of a limited time range for completion, access being asynchronous. This also allows the consultation of databases that would otherwise be prevented. The check on said databases makes the identification algorithm even more secure.

The qualified operator (which is in charge of the recognition) reviews all evidence and makes a comparison: in particular, he compares the photos present on the identity document with the user's face; checks that the documents are valid and the congruence of the dates therein; checks the documents for signs of deterioration and/or counterfeit; finally, he checks the holder's signature, if provided.

Moreover, the qualified operator 5 accesses to public databases such as the Ministry of the Interior, the Italian PRA, Experian and others and makes a search by document, possibly detecting the presence of complaints about theft and/or loss of documents. All search results are presented in a report and retained in a compliant manner along with the video by the entity that collects them (CA or Idp) for the duration required. The final section of the process requires that the qualified operator 5 (who is in charge of recognition):
i)- if certain of the user's identity, digitally signs the successful identification;
ii)- if not certain of the user's identity, reports the failed identification and defines the reason(s) thereof in an appropriate report.

Thereafter, an application call is made which automatically sends a text message to the stated holder's number (in case of a process initiated by mobile application), an email (in case of a process initiated from desktop) containing:
a- the instructions to continue and obtain the advanced electronic signature, the qualified electronic signature or the digital identity and a link; or
b- the notice of the impossibility to continue.

In the first case a-, user 1 via the indicated link accesses the application at the point of interest and reviews the contractual documentation relating to the service and expresses the wish to obtain the (advanced, qualified electronic signature or digital identity) service by means of an acceptance flag. Following such an access, user 1 receives the OTP (one time password) value on the indicated and validated mobile phone and, by the input of the value derived therefrom, confirms the registration application/application form.

The registration application/application form electronically signed by user 1 is automatically sent to digital storage and at the same time delivered to the user on a durable medium.

In a further preferred embodiment of the present invention, it is provided for the application verification of the congruence between the date of birth indicated on the identity document and the one on the social security code, as well as the application verification of the congruence of dates on the front and back of the social security code.

The alphanumeric string of the social security code based on the personal data present on the identity document is subjected to a corresponding verification of congruence with those found on the social security code.

Moreover, the back office operator 5 runs a check of the social security code on dedicated sites.

The following is also requested at the same time:
a- the congruence of the date of birth shown on the identity document and on the social security code;
b- the congruence of the expiration of identity document with respect to the current legislation and the current date;
c- the check of the matching of expiration dates at front and at the back of the social security code;
d- the check of the presence of a prior registration for the same mobile phone number with a different social security number;
e- the check of the presence of a prior registration for the same mobile phone number;
f- the check of the presence of a prior registration for the same email address;
g- the check of the presence of a prior registration for the same mobile phone number with a different home address;
h- the check of biometric data (facial and voice features) collected in prior registrations and present in the database.

Another technique that allows a potential fraud to be detected is to consider the smartphone's 3 camera as smartphone identification itself. Various publications are known on the identification of a camera model, starting from a frame or a digital photograph. The proposed methods are divided into two categories, depending on whether one wants to identify the model of the camera or the actual device (the make of a certain model with a serial number thereof).

In general, known identification methods are classified as passive or active methods. In the case of active methods, digital data representing the contents of the image are modified to include an identifier (also called watermarking method).

Passive methods proposed to solve the problem of identifying the origin of the images are based on the assumption that there are differences between models of devices, both for image processing techniques and for the technology of components, such as: lenses that cause optical aberrations, interpolation algorithm, etc., all of which are considered influential factors to identify the model of the camera.

For example, document WO2015145092 relates to techniques that allow identifying a model of camera from the analysis of a digital photograph, starting from an image taken by the same device.

The system uses evaluations based on statistics for the photographic image and relating to the subject camera, allowing the detection of the fingerprint on the mobile device used, and thus also allowing the comparison with previously stored fingerprints: the presence of two fingerprint that are sufficiently similar according to the thresholds defined by the CA/Idp will populate a black list and at the same time will be one of the parameters for the cataloguing of warning classes. In fact, the SW application directly provides the result of the examination of the fingerprint described above.

A further automatic detection of anomalies related to the mobile device is the operation which involves the assessment of the imperfection associated with the smartphone video sensor. In essence, the cameras fitted on mobile devices for telephony usually have defects not visible to the naked eye. For example, the problem of the conditions in which videos have small jerks (on the order of seconds), not visible looking through the phone device screen, but that are clearly visible and really annoying when exported to HD computer screens. Or, coma effects (or comatic aberration) are frequently detected, which occur with the transformation of a light point in a comet effect (similar to a comma). Or, there are lines in each frame, of different colors, such as green, red, etc. There is therefore a problem related to the presence of defects which are not detectable by the naked eye although sophisticated optical level adjustments, ISO settings, aperture, etc., are available.

According to the invention, the expert system performs a continuous cataloguing of such defects in a number of warning classes. When, during the registration and evaluation of the data entered, the operator saves in “image capture” mode the user's face, the user's identity card, front and back, the user's 1 social security code, front and back and the whole relative video, if repeating defects are detected they are attributed to the camera itself.

If for example the presence of small jerks of the order of a second are detected (not visible by looking through the camera, but only once they are exported to an HD computer screen), a comparison is concurrently carried out with the other identification data present in the database (associated in particular to a particular camera model) and having the same defect detected during the video filming so that through cross-checks on other typical identification data it is possible to establish any fraud attempt.

According to another preferred embodiment of the present invention, at the time of recording of the video, the user's biometric voice blob is stored. Such a blob is stored in a data base and, using a common voice biometrics software, is compared in 19 with every successive blob so as to not authorize suspicious accesses (for example a user registered with mismatched identification data).

Voice biometrics systems that have already previously stored the user's voice file with his voice print compare such a track with what will be pronounced during the video (or during the brief phone call scheduled as an option by the back office operator). The result of the match (percentage of compatibility) is stored by the entity CA/Idp.

As described, in fact, if the back office operator is not certain, he can schedule a call and ask for confirmation of some data: in this way, the expert system can also contextually compare the biometric data, such as voice, with the video previously viewed.

There are numerous applications that allow control on the identification of the speaker. An example of immediate application of this type of verification is the Nuance solution called transparent conversational authentication. Several Italian companies and research institutes have also provided effective solutions to the problem of identification of the person calling (Loquendo, or Fondazione Bordoni with the IDEM project, . . . ).

In yet a further embodiment of the present invention, when the procedure is initiated by mobile application, the user's location is traced based on the Global Positioning System present on the device.

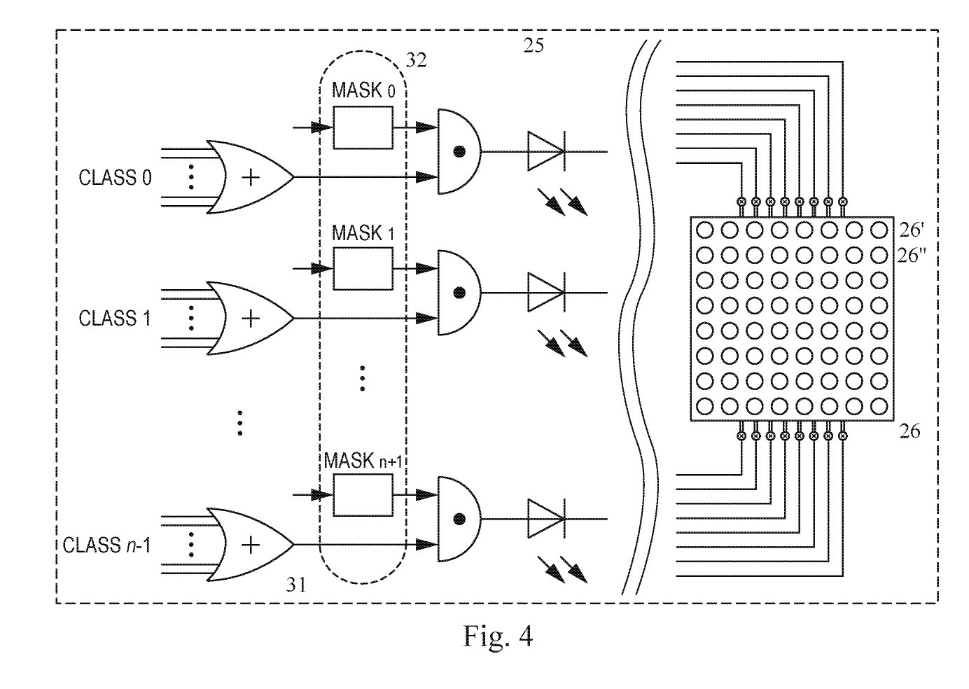

Given the large number of checks and the procedural complexity of their management, in one embodiment of the present invention, the check of the accuracy of the information provided in input by the user is logged when data is entered using a wired logic hardware expert system 25 of the type shown in FIG. 4. This basic logic provides an LED display or any commercially available digital display 26 and is interfaced directly with computer 30 of the back office portal.

Assuming that there are N checks executed in interactive mode, a wired network is responsible for storing the individual sounds: it makes a sort of history by recording the logic states associated with each data input activity.

At the time of verification performed asynchronously by operator 5—as a support to the operator himself who ultimately will be responsible for digitally signing the successful identification statement—such a wired logical network 25 has a further element of assessment from which one can infer if the data input path was linear or with difficulty or uncertainty.

A table or LED array 26 or any digital display available on the market is associated with such a wired network 31, 32, which detects the type of problem occurred, also taking into account the weight to associate thereto. In any case, the final evaluation is by operator 5 who digitally signs the successful identification statement.

The LED array or other display have additional uses. From an operational point of view, for example, it happens that operator 5, on a delayed basis when assessing a possibly fraudulent user's access, is detecting a series of unconvincing elements. At the same time, a sequence of diodes 26 will switch on, in the case of the LED array, or for example a numerical value will be displayed on the digital display, indicating the approach to alert conditions, as a significant number of identification information is proving inconsistent with one another.

In a particular embodiment of the LED display 26, which is any commercially available digital display, the display is split into n parts, taking a grouping based on columns (rows) of LEDs constituting each row (column). For example, the 8×8 matrix in FIG. 4 is seen in two sections by four columns for eight rows each, assuming eight warning classes are to detect and report. The division into 4+4 columns is linked to a solution which transposes the typical mantissa/exponent representation model in a discrete LED display scope. The aim is to distinguish between a mild warning signal of the first four columns and a serious warning signal of the other four columns. Let's assume that fraudulent access and an attempt to enter an ID from the vocabulary of codes have occurred (it is known that criminals have developed a series of random identifier or code generator techniques to gain access fraudulently), it is evident that the number of attempts with errors/uncertainties would become very high and any counting them would overflow. Therefore, this distinction of m of n columns is to indicate the occurrence of an overflow condition for the operator to have an immediate vision of the critical access attempted fraudulently.

The configuration that is evident is that of a hardware expert system 25 involving a multiplicity of agents on which the reliability and consistency of the information provided in input depend. In order to allow operator 5 to have an overall view of the verification process, the wired logic network in FIG. 4 is provided, with the LED array in which the various agents are divided into a number of warning classes and which provides a log containing the enabling mask of each class of agents. For example, a class of agents is the discrepancy in conversational authentication, another is the user's geolocation via GPS signals.

The switching on of LEDs 26^{m} or the appearance of a certain value on the digital display allow the operator to consider the presence of a given type of inconsistency. Ultimately, the LED diodes or the values on the digital display became active on the basis of selective processes that operate according to the instructions provided by the expert system 5 on the warning classes.

The essential characterizing therefore is that of a system where in fact there is a first step 11 of registration that the user feels he/she is managing autonomously. In reality this means, not obviously to the user, more control and greater robustness of the algorithm dedicated to security. This is because a software/hardware system is introduced which allows controlling, with a range of feedback, just the (non)linearity and uncertainty of the user who wanted to register fraudulently.

The diode sequence hardware is based on a multiplexer system that controls each LED sequence. The closer one gets to a condition of radical incongruity between the identifiers provided, the more the LED sequence 26 increases the blinking frequency, or otherwise green, yellow and red LEDs sequences are provided that gradually switch on. The LED array in the display device is provided, as mentioned, with a microprocessor which in turn inter-operates with a wireless interface that connects it to the computer unit 30. The microprocessor is powered by a power circuit which drives the wired logic with the LED sequences provided. The display device may also consist of any digital display available on the market.

An operator-end configuration according to the invention which makes use of the LED display 26, or any digital display available on the market, involves using an expert system 25 based on the use of a processor, this term meaning electrical circuitry that performs a set of instructions. This processor includes one or more integrated circuits, microchips, microcontrollers, microprocessors, all or part of a central processing unit, analog signal processor, etc.

The processor can be customized for particular uses and perform different functions by executing several software instructions. The instructions executed by the processor can, for example, be preloaded in the processor itself or be stored in a separate storage device such as a hard drive, an optical disc, a magnetic medium, flash memory, other permanent memories, either fixed or volatile, a RAM, a ROM or any other mechanism able to provide instructions to the processor.

According to the embodiments described herein, a processor can be configured to apply a plurality of diagrams to the LED display 26, or other digital display available on the market. The term “display model” may refer to the two-dimensional distribution of the sequences of illuminated diodes. Provision may be made for displaying an “A” to indicate a state of alert, or a “W” to indicate a condition of warning, and so on.

The inter-operation between the wired logic hardware unit 25 and processor 30 provided to operator 5 takes place via the dedicated I/O drivers that manage the communication between the I/O service requestor process and the output unit 25.

Interventions on the mask 32 are also provided by the operator who can anyway intervene on the individual warning classes through the sequence of logical switches 32. Keypads are provided, applied to each class 31, allowing the operator to consider only certain types of warning and exclude others. It may happen that, for example, in relation to a particular user who connects, voice reception is really bad, then the row of LEDs associated with the conversational authentication will be excluded through the mask. This means that if voice recognition was executed in conditions of significant ambient noise, whereby the recorded signals cannot be trusted, operator 5 may decide to disable mask “n” relating to the conversational authentication parameter. The wired logic-based hardware expert system 25 will define a new set of pre-configured parameters to determine whether one should provide an interrupt to the operation of processor 30.

### ADVANTAGES AND INDUSTRIAL APPLICABILITY OF THE INVENTION

By the present invention, the optimized check of the correct applicant's identification document detention is executed, based on an assessment of the congruence of the identification information provided.

The key advantages of the solution described result from the asynchrony between the identification data input process and the relative verification. As a result, the access modes to administrative and commercial services in general, such as opening a bank account, signing a contract for common users, etc., are more flexible. Innovation consists in placing this operational temporal separation between the moment of the verification with respect to the moment in which the recognition is carried out. Despite the completely autonomous first step, the back office operator 5 still performs the checks accurately and in depth by comparing evidence 6 and queries the available databases. In the first step, also the biometric data are collected which at an evidential level, are difficult to rebut.

Further advantageous aspects of the present invention are the apparent reduction in the number of operators needed to make the recognitions, as well as the fact that the operator needs not be waiting for a call but can schedule his contacts. The downtime of each will also be significantly reduced. The present invention therefore significantly reduces the unit cost of an identification and such service may be economically viable also for signing documents or low value contracts (such as buying a SIM card, for example). A further advantage of the solution is the ability to be available in all languages, the one-time translation of steps described to the user being sufficient: in fact, the operators are not required to have skills in several languages, not having to converse with users on screen. This last advantage consequently allows the use of the solution in international contexts, actually operating a standardization.

Finally, the asynchrony of the solution allows, on the one hand, 24/7 availability for self-made operations and, on the other hand, it makes the back office activities of operators stress-free: the latter in fact have plenty of time to carry out the verification they are in charge of, without having to answer to a user waiting at the other end. A further advantage of asynchrony is the total lack of care on the part of service providers of the image of their brand (as any roll-up to be used behind operators, etc.).

The implemented solution has clear security elements. A voice print is used, with voice biometric systems for the subsequent matching. The signature specimens and identity documents are always stored by the CA. Moreover, the wizard is able to propose steps 11a, 11b, 11c in random order.

Moreover, the increased security resulting from data verification in different databases accessible is clear, as there are no binding time to access the same.

1. Method of identifying a physical person aimed to obtain an advanced electronic signature, a qualified electronic signature or digital identity through the authentication to a mobile or desktop application, the activation of which requires the presence of a functioning audio-video system and an internet connection, wherein the identification is made in two distinct operating steps (I, II) relative to each other through the following steps:
I-i- a user (1) accesses the mobile (3) or desktop (2) application and start the registration process by entering his/her personal data: first name, last name, social security number, date and place of birth, mobile phone number, home address, type and number of identity document;
I-ii- the user (1) reads the complete privacy policy on the processing of identification and biometric data;
I-iii- the user (1) gives his/her mandatory consent to the processing of data by setting an acceptance flag;
I-iv- the user (1) start, via encrypted channel, the wizard screen procedure following the steps indicated through audio and/or video messages proposed in random order by the application;
I-v- the user is required to register comprising the certification of the mobile phone number by receipt and subsequent input, in a dedicated field, of a control code or a derivative thereof, sent on the user's (1) device, at the end of the registration, the latter being automatically sent to a back office system (4) via encrypted channel;
I-vi- the back office system (4) receives the video recorded by the user (1) and sets it up to be managed by an available qualified operator (5), in charge of the identification;
II-i- the qualified operator (5), in charge of the identification, in asynchronous mode with respect to the video recording, times-stamps it upon reception and sets up the execution of the prescribed checks in order to identify the user (1);
II-ii- the qualified operator (5), in charge of the identification, saves the following evidence in “image capture” mode:
a- user's face;
b- front and rear of the user's identification document;
c- front and rear of the user's (1) social security number;
II-iii- the qualified operator (5), in charge of the identification reviews all evidence and compares it, in particular by verifying:
the photo on the identification document with respect to the user's (1) face;
that the documents are valid and that the dates shown therein are congruent;
that the documents show no signs of deterioration and/or counterfeiting;
the presence of the holder's signature, if required;
II-iv- the qualified operator (5), in charge of the registration, accesses the dedicated databases and searches by document, possibly also checking the presence of complaints of theft and/or loss, all research results merging into a report and being stored according to the standards along with the video;
II-v- the qualified operator (5) in charge of the identification:
II-v-a′ if certain of the user's (1) identity, digitally signs the successful identification;
II-v-b′ if not certain of the user's (1) identity, reports the failed identification and defines the reason(s) thereof in a report;
II-vi- an application call is made which automatically sends
a text message to the indicated user's (1) number (in the case of process initiated by mobile application),
an email, in case of process initiated by desktop, containing:
II-v-a″- the instructions to continue and obtain the advanced, qualified electronic signature or digital identity and a link;
II-v-b″- the notice of the impossibility to continue.
II-vii- the user (1), in case II-v-a, via the indicated link accesses the application at the point of interest and reviews the contractual documentation relating to the service and expresses the wish to obtain the advanced, qualified electronic signature or digital identity service by means of one or more acceptance flags;
II-viii- the user (1) receives the OTP—one time password—value on the indicated and validated mobile phone by the input of the value derived therefrom, confirming the registration application/application form;
II-ix- the application/adhesion form signed by the user (1) is automatically sent to be digitally stored and at the same time is delivered to the user (1) on a durable medium, along with any instructions for using the certificate, if the latter can be used in repetitive mode.

2. Method of identifying a physical person according to claim 1, wherein real-time application checks are provided for the identification data present and displayed by the documents subject to capture and the user's (1) input data, as well as the expiration dates printed on the front and back of the social security card.

3. Method of identifying a physical person according to claim 1, wherein the following application checks are provided:
the presence of a prior registration for the same mobile phone number with a different social security number;
the presence of a prior registration for the same mobile phone number;
the presence of a prior registration for the same email address;
the presence of a prior registration for the same mobile phone number with a different home address.

4. Method of identifying a physical person according to claim 1, wherein upon recording the video, the user's (1) biometric voice blob is stored, said blob being stored in a database and, through the use of a common voice biometrics software, compared with each successive blob so as to not authorize suspicious accesses, such as a same user registered with identification data not matching.

5. Method of identifying a physical person according to claim 1, wherein—when the process is initiated by mobile application—the user's (1) location is traced based on the Global Positioning System present on the device and, in case of fraud attempt, an alert system is activated which notifies the details of the call to the certificate issuer and to any third parties involved.

6. Method of identifying a physical person according to claim 1 wherein, based on the location detection through the GPS signal, the user (1) is consequently asked to speak out the place from which he/she is accessing.

7. Method of identifying a physical person according to claim 1, wherein the back office operators (5) carry out a continuous cataloguing of the imperfections in the capture associated with cameras with which the videos are made by simultaneously carrying out, for each recording, a comparison with other imperfection identifiers in the database having the same defect detected in the video capture step, so that through cross-checks on other identification elements, any fraud attempt is ascertained.

8. Method of identifying a physical person according to claim 1, wherein the tracking and contextual storing of the IP number of the device used for the user's self-made session as well as the MAC address are provided.

9. Hardware device to be used in the remote identification method of a person according to claim 1, comprising a microprocessor which in turn cooperates with a wireless interface that connects it to the computer (30) of the qualified operator (5), said microprocessor being powered by a power circuit that feeds a dedicated hardwired logic (31), further comprising a display interfaced with the hardwired logic which displays specific alerts depending on the degree of alert/warning detected, hence highlighting the severity of the fraud risk for the case under review via an interactive display, on the basis of warning classes managed by the operator (5) himself/herself which each time evaluates the occurrence of an anomaly.

10. Hardware signaling device to be used in the remote identification method of a person according to claim 1, wherein the display consists of an array of LEDs (26) of n rows by m columns, and/or of any other digital display available on the market, which reproduce a sequence of light signals the one, and a value, such as numerical, the other, in order to classify the anomalies that occur in the registration.

11. Hardware signaling device to be used in the remote identification method of a person according to claim 1, wherein the display consisting of an array of LEDs (26) of n rows by m columns works on two groups of distinct columns, with a configuration that transposes the typical mantissa/exponent representation model in discrete display, distinguishing the anomalies that occur during the registration between a mild warning signal of the first m/2 columns and a serious warning signal on the second other m/2 columns.

12. The method of claim 2, wherein the input data comprises the date of birth shown on the identity document and the social security card.

13. Method of identifying a physical person according to claim 2, wherein the following application checks are provided:
the presence of a prior registration for the same mobile phone number with a different social security number;
the presence of a prior registration for the same mobile phone number;
the presence of a prior registration for the same email address;
the presence of a prior registration for the same mobile phone number with a different home address.

14. Method of identifying a physical person according to claim 2, wherein upon recording the video, the user's (1) biometric voice blob is stored, said blob being stored in a database and, through the use of a common voice biometrics software, compared with each successive blob so as to not authorize suspicious accesses, such as a same user registered with identification data not matching.

15. Method of identifying a physical person according to claim 3, wherein upon recording the video, the user's (1) biometric voice blob is stored, said blob being stored in a database and, through the use of a common voice biometrics software, compared with each successive blob so as to not authorize suspicious accesses, such as a same user registered with identification data not matching.

16. Method of identifying a physical person according to claim 2, wherein—when the process is initiated by mobile application—the user's (1) location is traced based on the Global Positioning System present on the device and, in case of fraud attempt, an alert system is activated which notifies the details of the call to the certificate issuer and to any third parties involved.

17. Method of identifying a physical person according to claim 3, wherein—when the process is initiated by mobile application—the user's (1) location is traced based on the Global Positioning System present on the device and, in case of fraud attempt, an alert system is activated which notifies the details of the call to the certificate issuer and to any third parties involved.

18. Method of identifying a physical person according to claim 4, wherein—when the process is initiated by mobile application—the user's (1) location is traced based on the Global Positioning System present on the device and, in case of fraud attempt, an alert system is activated which notifies the details of the call to the certificate issuer and to any third parties involved.

19. Method of identifying a physical person according to claim 2 wherein, based on the location detection through the GPS signal, the user (1) is consequently asked to speak out the place from which he/she is accessing.

20. The method of claim 8, wherein the IP number of the device used for the user's self-made session as well as the MAC address are used to perform an automatic comparison for each subsequent registration.
